(19) United States
(12) Patent Application Publication
(10) Pub. No.: US 2008/0294448 A1
(43) Pub. Date: Nov. 27, 2008

(54) Methods and systems associated with telephone directory advertisements

(75) Inventor: Zane C. Holtzclaw, St. Peters, MO (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/805,555

(22) Filed: May 23, 2007

(51) Int. Cl. G06Q 30/00

(52) U.S. Cl. 705/1

(57) ABSTRACT

A telephone directory advertisement is created for an advertiser by an artist during a Web teleconference session based on an interaction via the Web teleconference session between the artist, the advertiser, and a sales representative.

### FIELD OF THE DISCLOSURE

The present disclosure is generally related to methods and systems associated with telephone directory advertisements.

### BACKGROUND

A telephone directory business may provide an in-house design team of artists who create telephone directory advertisements for customers who wish to advertise in a telephone directory (e.g. a Yellow Pages directory). The in-house design team may employ artists at multiple local sales branch offices. Customers who wish to advertise may be invited to visit one of the local sales branch offices to participate in a design session with one of the artists. In a survey of customers who participated in the above-described design session, a majority indicated that this service favorably influenced their decision to buy advertising in a particular telephone directory. However, the number of branch locations and their local level of resources limit widespread use of this service. For customers who prefer not to visit a local sales branch office, the in-house design service may provide a mobile design service that travels to the customer locations. The mobile design service provides advertisement-creation capabilities at the customer locations.

The telephone directory business may provide sales representatives who act as liaisons between the customers and the artists. A sales representative may have numerous contacts at different times with a particular customer and a particular artist to facilitate creation of a speculative concept for a particular advertisement and subsequent customization of the speculative concept for the particular customer. For example, the sales representative may have an initial contact with the particular artist to formulate a speculative concept, followed by an initial contact with the particular customer to show the speculative concept and determine his/her wishes for the particular advertisement, followed by another contact with the particular artist to convey the particular customer's wishes, followed by yet another contact with the particular artist to receive a draft of the particular advertisement, followed by one or more other contacts with the particular customer to review the draft, followed by one or more other contacts with the artist to revise the draft based on review(s) by the particular customer and/or the sales representative. The sales representative may have subsequent contacts associated with the particular advertisement if subsequent iterations of review and modification are performed.

The number of contacts involving a sales representative for a particular advertisement may be undesirably large in some cases. Further, the creation of the particular advertisement may require an undesirably large investment in time by the sales representative and/or the customer.

### BRIEF DESCRIPTION OF THE DRAWINGS

FIG. 1 is a block diagram of an embodiment of a system for creating telephone directory advertisements;

FIG. 2(A-B) is a flow chart of an embodiment of a method of creating a telephone directory advertisement;

FIG. 3(A-D) is a flow chart of another embodiment of a method of creating a telephone directory advertisement; and

FIG. 4 is a block diagram of an illustrative embodiment of a general computer system.

### DETAILED DESCRIPTION OF THE DRAWINGS

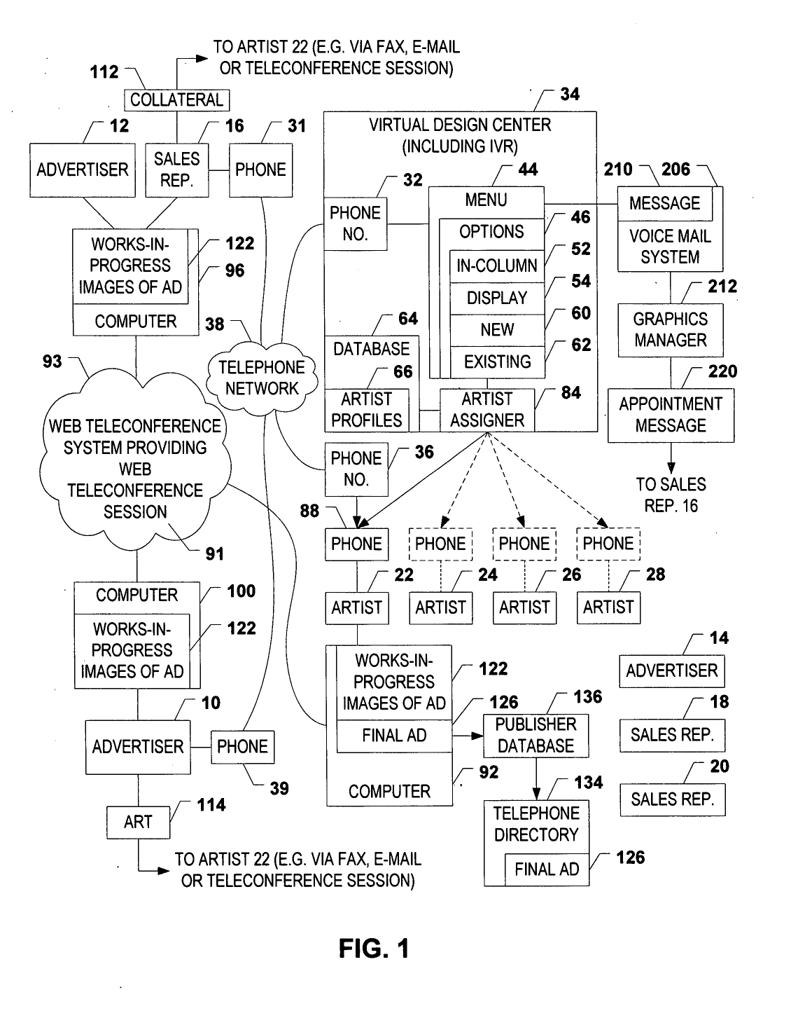

Disclosed herein are embodiments of a virtual design center, such as an embodiment depicted in FIG. 1, that enables advertisers (which may also be referred to as customers), sales representatives of a telephone directory business and artists to collaborate on advertising design concepts in real-time from any location. Although the virtual design center can be used for any number of advertisers, sales representatives and artists, FIG. 1 shows three advertisers 10, 12 and 14, three sales representatives 16, 18 and 20, and four artists 22, 24, 26 and 28 for purposes of illustration and example.

Using the virtual design center, acts of negotiation, advertisement concept creation, advertisement customization, and customer approval can be completed in one combined-effort event. The virtual design center enables a larger pool of artists 22, 24, 26 and 28 to handle advertisement creation activities regardless of the locations of the advertisers 10, 12 and 14 and the sales representatives 16, 18 and 20. The virtual design center reduces a number of contacts involving the sales representatives 16, 18 and 20, reduces an amount of time invested by the sales representatives 16, 18 and 20, reduces an amount of time invested by the advertisers 10, 12 and 14, and provides improved customer service. The virtual design center also leverages a perceived value to an advertiser of having a design session with an artist. Downstream manufacturing processes of publishing resulting telephone directory advertisements may be streamlined or may otherwise benefit from upfront activities of the virtual design center.

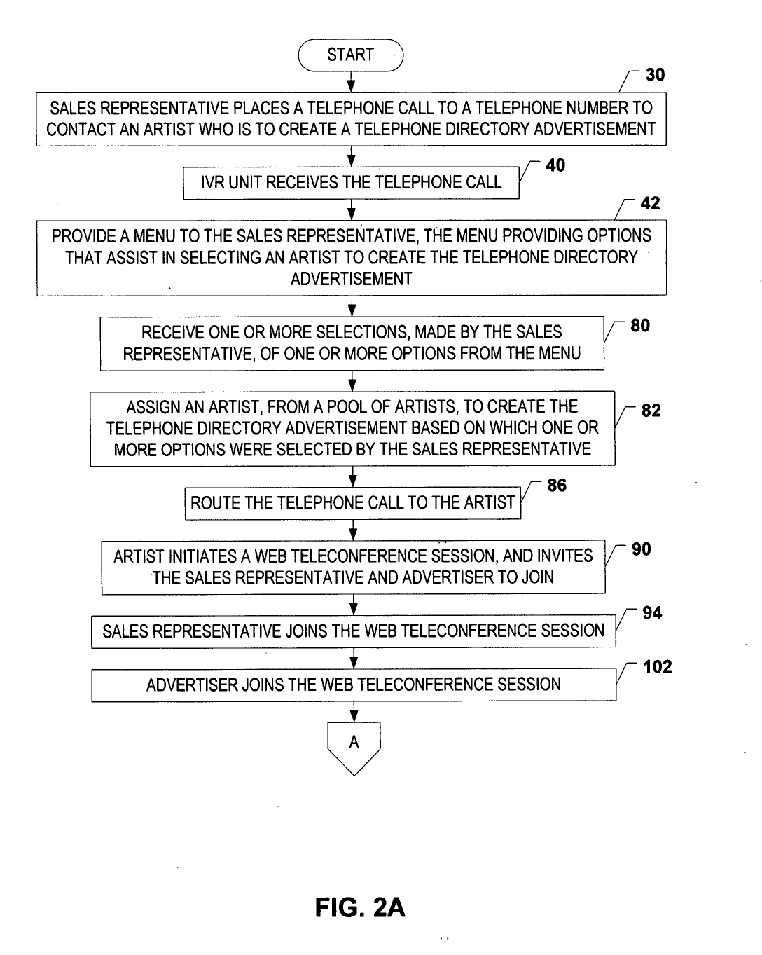

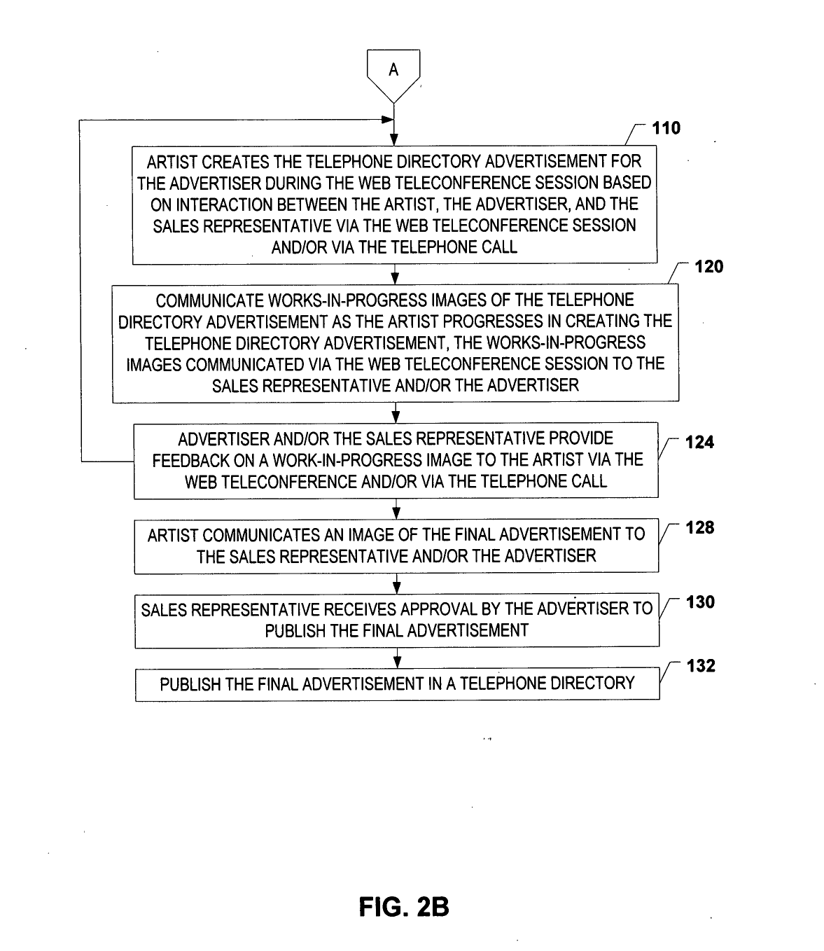

FIG. 2(A-B) is a flow chart of an embodiment of a method of creating a telephone directory advertisement using the system of FIG. 1. For purposes of illustration and example, the telephone directory advertisement is to be created for either the advertiser 10 or the advertiser 12 with the sales representative 16 acting as a liaison. The method contemplates both premise sales (when the sales representative 16 is physically present with the advertiser 12, e.g. at a premise of the advertiser 12) and remote sales (e.g. when the sales representative 16 is remotely located from the advertiser 10, e.g. when the sales representative 16 is not physically present at the premise of the advertiser 10). For ease of discussion, the embodiment of the method is described for the case of a remote sale involving the sales representative 16 and the advertiser 10.

As indicated by block 30, the method comprises the sales representative 16 placing a telephone call to a telephone number to contact an artist who is to create the telephone directory advertisement. The sales representative 16 may use a telephone 31 to place the telephone call.

The telephone number may be a central telephone number 32 that the sales representatives 16, 18 and 20 call in order to contact any of the artists 22, 24, 26 and 28. The central telephone number 32 may be for an interactive voice response (IVR) unit of a virtual design center 34. The IVR unit provides one or more menus of options to the sales representative 16, receives and processes one or more options selected by the sales representative 16 (e.g. using dialed inputs and/or voice inputs), and routes the call to one of the artists 22, 24, 26 and 28 based on the one or more selected options. Alternatively, the telephone number 32 may be a telephone number 36 that is a dedicated contact number for a particular artist that is to create the telephone directory advertisement for the advertiser 10. In either case, the telephone number may be a toll-free or called-party-pays telephone number, and the telephone call may be provided by a telephone network 38.

For remote sales, the telephone call may be a three-way call that also includes the advertiser 10 as a party thereto. The three-way call enables the sales representative 16, the advertiser 10, and an artist to interact in a virtual design session in which the artist creates the telephone directory advertisement. The advertiser 10 can use his/her telephone 39 to communicate in the telephone call.

If the telephone call is placed to the central telephone number 32, the IVR unit receives the telephone call, as indicated by block 40. As indicated by block 42, the IVR unit provides a menu 44 to the sales representative 16 within the telephone call. The menu 44 provides a plurality of options 46 that assist in selecting which of the artists 22, 24, 26 and 28 should be assigned to create the telephone directory advertisement. The options 46 may include a plurality of different advertisement type options, e.g. an in-column advertisement option 52 and a display advertisement option 54. The options 46 may further include a plurality of advertisement status options, e.g. an existing advertisement option 60 and a new advertisement option 62. In an embodiment, the options 46 do not specifically identify any particular one of the artists 22, 24, 26 and 28. For purposes of illustration and example, the menu 44 may inform the sales representative 16 to “press 1 for an in-column ad, press 2 for a display ad, press 3 for an existing ad, and press 4 for a new ad”.

A database 64 stores profiles 66 for the artists 22, 24, 26 and 28 as computer-readable data in one or more computer-readable media. An artist's profile indicates which of the advertisement types his/she is best suited to create, and his/her current availability for creating an advertisement. For example, the profiles 66 may indicate that the artists 22 and 24 are best skilled at creating display ads, and that artists 26 and 28 are best skilled at creating in-column ads. The profiles 66 may further indicate that the artists 22 and 28 are presently available to handle an incoming call, and that the artists 24 and 26 are presently unavailable to handle an incoming call (e.g. the artist 24 may be presently creating another telephone directory advertisement, and the artist 26 may be on vacation).

As indicated by block 80, the method comprises receiving one or more selections, made by the sales representative 16, of one or more options from the menu 44. The IVR unit receives the one or more selections.

As indicated by block 82, the method comprises assigning, from the pool of artists 22, 24, 26 and 28, an available artist to create the telephone directory advertisement for the advertiser 10 based on which one or more options were selected by the sales representative 16. An artist assigner 84 accesses the database 64 of the profiles 66 for the artists 22, 24, 26 and 28 to automatically assign the available artist to the telephone call. For purposes of illustration and example, consider the artist 22 being assigned to create the telephone directory advertisement because of his/her skill in creating display ads and his/her present availability.

As indicated by block 86, the method comprises routing the telephone call to the artist 22 that was assigned to create the telephone directory advertisement. The IVR unit causes the telephone call to be directed to a telephone 88 of the artist 22. The artist 22 answers the telephone call and uses the telephone 88 to communicate with the sales representative 16 and the advertiser 10.

As indicated by block 90, the artist 22 initiates a Web teleconference session 91 using his/her computer 92. The Web teleconference session 91 is initiated to provide a virtual design session involving the artist 22, the sales representative 16, and the advertiser 10. The Web teleconference session 91 may be provided by a Web teleconferencing system 93 that provides a service (e.g. AT&T's Web Meeting service or e-Conference service, or another branded service) that provides a visual component to conference calls. The Web teleconferencing system 93 cooperates with one or more different software applications (e.g. a graphic design or illustration program such as Macromedia FreeHand® from Adobe) being executed by the computer 92 to enable the artist 22 to present his/her visual designs to other participants of the Web teleconference session 91 in real-time over the Internet. The Web teleconference session 91 further enables collaboration between the artist 22 and the other participants in real-time over the Internet. The artist 22 invites the sales representative 16 and the advertiser 10 to join the Web teleconference session 91.

Examples of features provided by the Web teleconferencing system 93 for any session include, but are not limited to: a desktop sharing feature wherein participants can share substantially any software application that resides on their personal computer; a whiteboard feature wherein participants can use a public easel to make notes and/or sketches; a chat feature wherein participants can send text messages either to all members of a conference or privately to a specific member of the conference; an application share control feature wherein hosts can share control of the presentation with participants, but participants can only modify the presentation if granted control by the host; a file transfer feature wherein participants can upload and download files; a polling feature wherein hosts can create a survey online and results thereof can be tabulated immediately and shared with all participants; a record-and-playback feature wherein the host and/or participants can record the entire web and audio meeting to be played back at any time; a video feature wherein participants can see a host or an object under discussion in the meeting; and Secure Socket Layer (SSL) encryption to SSL-encrypt all data traveling to and from servers which provide the Web teleconferencing system 93. Preferably, the service enables anyone with Internet access and a standard browser can participate in a session, and thus requires no additional software or hardware.

As indicated by block 94, the sales representative 16 joins the Web teleconference session 91 using his/her computer 96. For remote sales applications, the advertiser 10 also joins the Web teleconference session 91 using his/her computer 100, as indicated by block 102. The sales representative 16 and/or the advertiser 10 may join the Web teleconference session 91 using a wireline network connection or a wireless network connection. Regardless of whether it is wireline or wireless, the network connection may be a broadband Internet connection. An example of a wireless network connection is provided by Cingular's BroadbandConnect service.

As indicated by block 110, the method comprises the artist 22 creating the telephone directory advertisement for the advertiser 10 during the Web teleconference session 91. The artist 22 creates the telephone directory advertisement using his/her computer 92 based on interaction between the artist 22, the advertiser 10, and the sales representative 16 via the Web teleconference session 91 and/or via the telephone call. The artist 22 may create the telephone directory advertisement based on collateral information 112 received from the sales representative 16. The collateral information 112 may include images and/or text that are sent via e-mail, fax, or via the Web teleconference session 91, for example. The artist 22 may create the telephone directory advertisement based on art 114 provided by the advertiser 10. The art 114 may include a logo of the advertiser 10, a picture of a product to be advertised, a picture of a location to be advertised, a picture of an individual to be advertised, or any combination thereof, for example. The art 114 may be sent from the advertiser 10 to the artist 22 via the Web teleconference session 91. Alternatively, the artist 22 may use his/her computer 92 to download the art 114 from a Web site of the advertiser 10.

As indicated by block 120, the method comprises communicating, from the artist 22 to the sales representative 16 and/or to the advertiser 10 via the Web teleconference session 91, one or more works-in-progress images 122 of the telephone directory advertisement as the artist 22 progresses in creating the telephone directory advertisement. The works-in-progress images 122 are displayed by the computer 96 of the sales representative 16 and/or by the computer 100 of the advertiser 10 before the artist 22 has completed creating the telephone directory advertisement. The sales representative 16 and/or the advertiser 10 can view the works-in-progress images 122 and provide immediate feedback to the artist 22 via the Web teleconference session 91 and/or via the telephone call (as indicated by block 124). The feedback may indicate suggestions of the sales representative 16 and/or the advertiser 10 on changes to the current version of the telephone directory advertisement. The artist 22 incorporates the feedback, in real-time, to create the telephone directory advertisement in accordance with the desires of the advertiser 10 and/or the sales representative 16.

When the creation of the telephone directory advertisement has been completed based on one or more iterations of feedback, the artist 22 communicates an image of the final ad 126 to the sales representative 16 and/or the advertiser 10, as indicated by block 128. The final ad 126 can be communicated using a file transfer function of the Web teleconference session 91 or by an alternative means (e.g. e-mail or fax). The final ad 126 may be in a file format such as PDF or JPEG, for example. The computer 96 and/or the computer 100 receive the final ad 126, and display the final ad 126 for view by the sales representative 16 and the advertiser 10.

As indicated by block 130, the sales representative 16 obtains an approval by the advertiser 10 to publish the final ad 126. The approval may be received from the advertiser 10 either during or after the Web teleconference session 91. As indicated by block 132, the final ad 126 is published in a telephone directory 134 after receipt of the approval. The telephone directory 134 may comprise a printed telephone directory (e.g. a Yellow Pages® directory) and/or an online telephone directory that is published by a telephone directory publisher. One or more intervening acts may be performed between approval and publication. For example, the final ad 126 may be uploaded to a publisher database 136. The publisher database 136 stores, as computer-readable data on computer-readable media, a plurality of telephone directory advertisements that are to be listed in the telephone directory 134. The telephone directory, 134 is constructed based on the telephone directory advertisements stored in the publisher database 136.

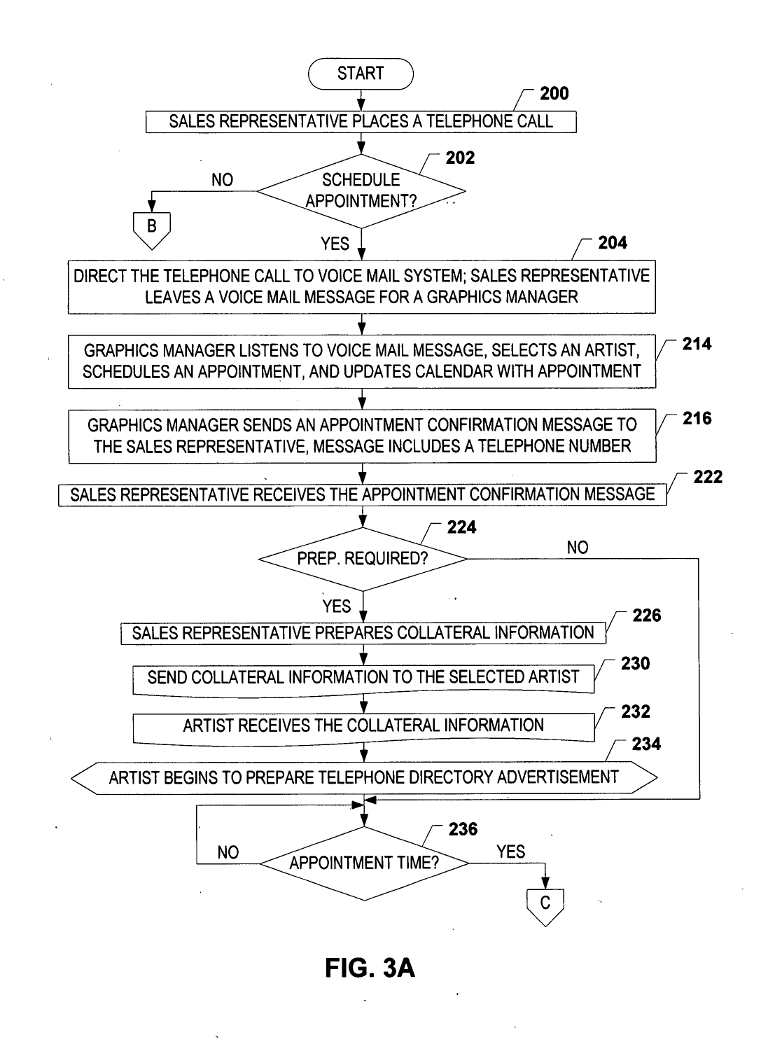

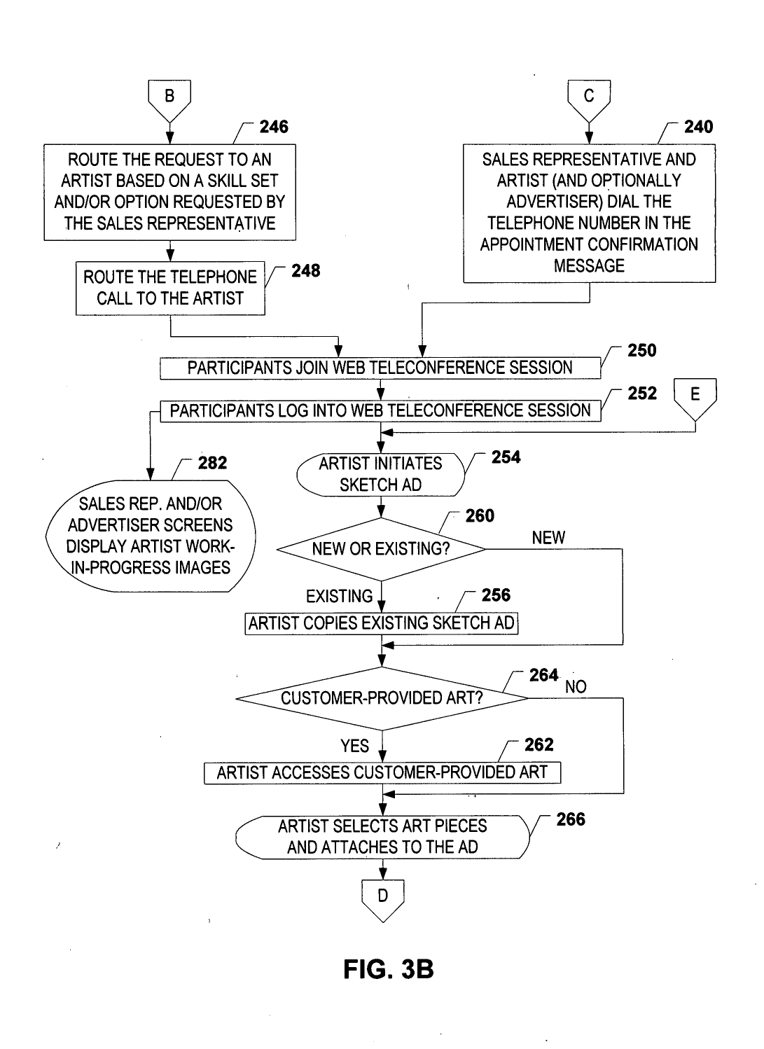

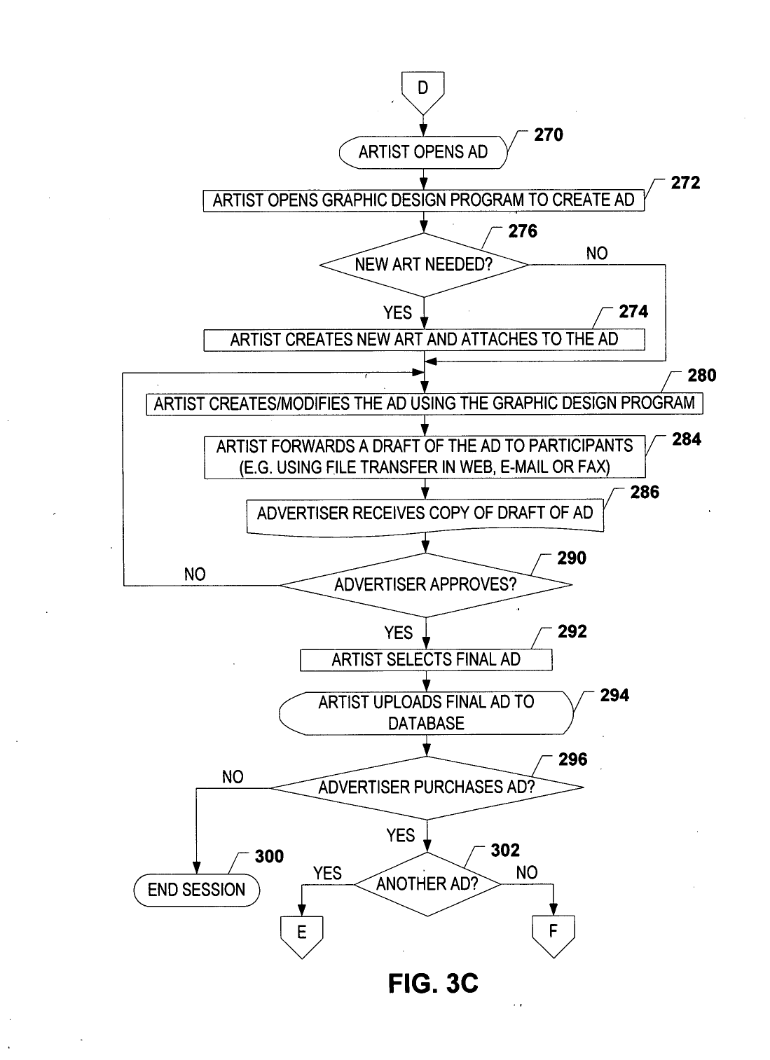

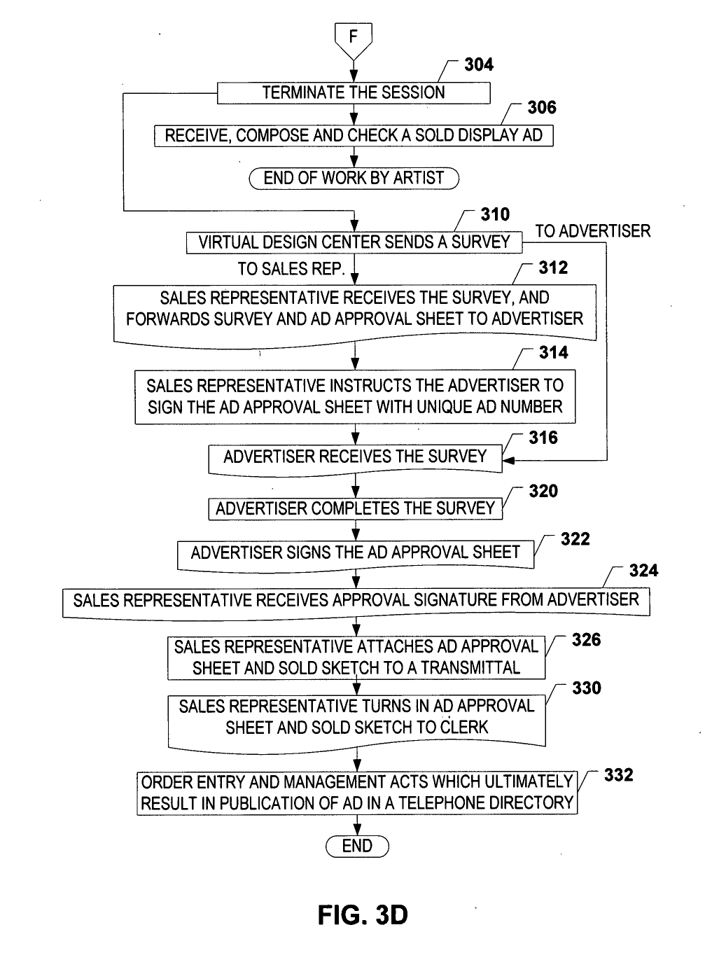

FIG. 3(A-D) is a flow chart of another embodiment of a method of creating telephone directory advertisements using the system of FIG. 1.

As indicated by block 200, the sales representative 16 places a telephone call to the central telephone number 32 of the virtual design center 34. The central telephone number 32 may be an “800” or another toll-free number. As indicated by block 202, the virtual design center 34 provides an option to schedule an appointment for a virtual design session, and an option to conduct a virtual design session during the telephone call.

If an appointment is to be scheduled, flow of the method is directed to block 204 wherein the telephone call is directed to a voice mail system 206 so that the sales representative 16 can leave a voice mail message 210 for a graphics manager 212. The voice mail message 210 may indicate preferred dates and/or times for the appointment, and/or a type of telephone directory advertisement (e.g. either in-column or display) that is to be created, and/or other specifics associated with the telephone directory advertisement that is to be created.

As indicated by block 214, the graphics manager 212 listens to the voice mail message 210 and schedules the appointment. The graphics manager 212 selects which artist (e.g. the artist 22) is to create the telephone directory advertisement and updates a calendar to include an appointment with the artist at a particular date and time.

As indicated by block 216, the graphics manager 212 sends an appointment confirmation message 220 to the sales representative 16. The appointment confirmation message 220 may include a telephone number to call (e.g. either a conference call number, the telephone number 32, the telephone number 88, or another telephone number), a link and/or password to access the Web teleconference session 91, and a name of the artist 22. The appointment confirmation message 220 may also request the collateral information 112 if any preparation thereof is required by the sales representative 16. The appointment confirmation message 220 may be sent via e-mail (e.g. to the computer 96 of the sales representative 16), fax, or another means of communication.

As indicated by blocks 222 and 224, the sales representative 16 receives the appointment confirmation message and determines if preparation of the collateral information 112 is required. The collateral information 112, if required, is prepared and sent to the artist 22 before the scheduled appointment time, as indicated by blocks 226 and 230. The collateral information 112 may be sent from the sales representative 16 to the artist 22 via either Web file transfer, e-mail, fax or another means of communication. As indicated by blocks 232 and 234, the artist 22 receives the collateral information 112 and may begin to prepare the telephone directory advertisement based thereon before the scheduled appointment time.

As indicated by block 236, the sales representative 16, the artist 22, and optionally the advertiser 10 wait until about the scheduled appointment time before conducting the virtual design session. As indicated by block 240, the sales representative 16, the artist 22, and optionally the advertiser 10 dial the telephone number in the appointment confirmation message 220 to join a conference call.

Referring back to block 202, if the virtual design session is requested to be conducted during the telephone call, flow of the method is directed to block 246 wherein the request is automatically routed to an artist (e.g. the artist 22) based on a skill set and/or option requested by the sales representative 16. As indicated by block 248, the telephone call is routed to the artist (e.g. to the artist 22).

Regardless of whether or not the virtual design session is by appointment, the method comprises all participants (e.g. the artist 22, the sales representative 16 and the advertiser 10) joining and logging into the Web teleconference session 91, as indicated by blocks 250 and 252.

The artist 22 creates the telephone directory advertisement for the advertiser 10 based on an interaction via the Web teleconference session 91 and/or via the conference call between the artist 22, the advertiser 10, and a sales representative 16. For example, the artist 22 may perform any combination of: initiating a sketch ad (block 254), copying an existing sketch ad (block 256) if the existing sketch ad exists (block 260), accessing customer-provided art 114 (block 262) if the customer-provided art 114 is to be included (block 264), selecting art pieces to attach to the ad (block 266), opening the ad (block 270), opening a graphic design program to create the ad (block 272), creating new art and attach to the ad (block 274) if the new art needs to be created (block 276), and creating/modifying the ad using the graphic design program (block 280). As indicated by block 282, the works-in-progress images 122 of the ad from the graphic design program are displayed to the sales representative 16 and/or the advertiser 10 via the Web teleconference session 91 as the artist 22 creates the ad using any of the aforementioned acts.

As indicated by block 284, the artist forwards a draft of the ad to the sales representative 16 and/or to the advertiser 10. The ad may be forwarded using either a file transfer function of the Web teleconference system 93, a file transfer function of the Web, e-mail, or fax. As indicated by block 286, the advertiser 10 receives a copy of the ad. As indicated by block 290, the advertiser 10 determines whether or not to approve the ad for publication. If the draft is not approved by the advertiser 10, flow of the method is directed back to block 280 wherein the artist 22 further modifies the ad based on feedback from the advertiser 10. If the ad is approved by the advertiser 10, the ad is considered to be a final ad 126. As indicated by blocks 292 and 294, the final ad 126 is selected by the artist 22 and uploaded to the publisher database 136. As indicated by blocks 296 and 300, if the advertiser 10 decides not to purchase the final ad 126 for publication, the Web teleconference session 91 is terminated. If the advertiser 10 decides to purchase the final ad 126 for publication, the artist 22 determines if there is another ad to create in the virtual design session (block 302). If another ad is to be created in the virtual design session, flow of the method is directed back to block 254. If no further ad is to be created in the virtual design session, the Web teleconference session 91 is terminated (block 304). As indicated by block 306, additional acts of receiving, composing and checking a sold ad may be performed by the artist 22 after the virtual design session has terminated.

As indicated by block 310, the virtual design center 34 sends a survey either directly to the advertiser 10 or indirectly to the advertiser 10 via the sales representative 16. The survey allows the advertiser 10 to evaluate aspects of the virtual design session. The survey may be sent to the sales representative 16 if the advertiser 10 is not online, for example. In this case, as indicated by block 312, the sales representative 16 receives the survey, and provides the survey to the advertiser 10. The sales representative 16 further provides an ad approval sheet to the advertiser 10. The ad approval sheet includes a unique ad identifier (e.g. a unique ad number) that uniquely identifies the final ad 126 in the database 136, and a date stamp and time stamp that indicates when the final ad 126 was uploaded to the database 136. The ad approval sheet may or may not include a printout of the final ad 126 or an earlier draft thereof. Any of the unique ad identifier, date stamp and time stamp may be printed by a computer or may be handwritten (e.g. by the sales representative 16). As indicated by block 314, the sales representative 16 instructs the advertiser 10 to sign the ad approval sheet to document his/her approval of the final ad 126.

As indicated by block 316, the advertiser 10 receives the survey and the ad approval sheet from the sales representative 16 and/or the virtual design center 34. As indicated by blocks 320 and 322, the advertiser 10 completes the survey and signs the ad approval sheet. If the survey is a printed survey (e.g. on an addressed post card), the advertiser 10 mails the completed survey to a mailing address associated with the virtual design center 34. As indicated by block 324, the sales representative 16 receives the ad approval sheet with the approval signature from the advertiser 10. As indicated by blocks 326 and 330, the sales representative 16 attaches the ad approval sheet and sold sketch to a transmittal, and turns in same to a clerk. As indicated by block 332, one or more subsequent order entry and management acts may be performed which ultimately result in the publication of the final ad 126 in the telephone directory 134.

It is noted that either a Web survey or a survey-function of the Web teleconferencing system 91 may be used as an alternative to a printed survey. It is further noted that the herein-disclosed embodiments can be adapted for use in creating advertisements other than telephone directory advertisements.

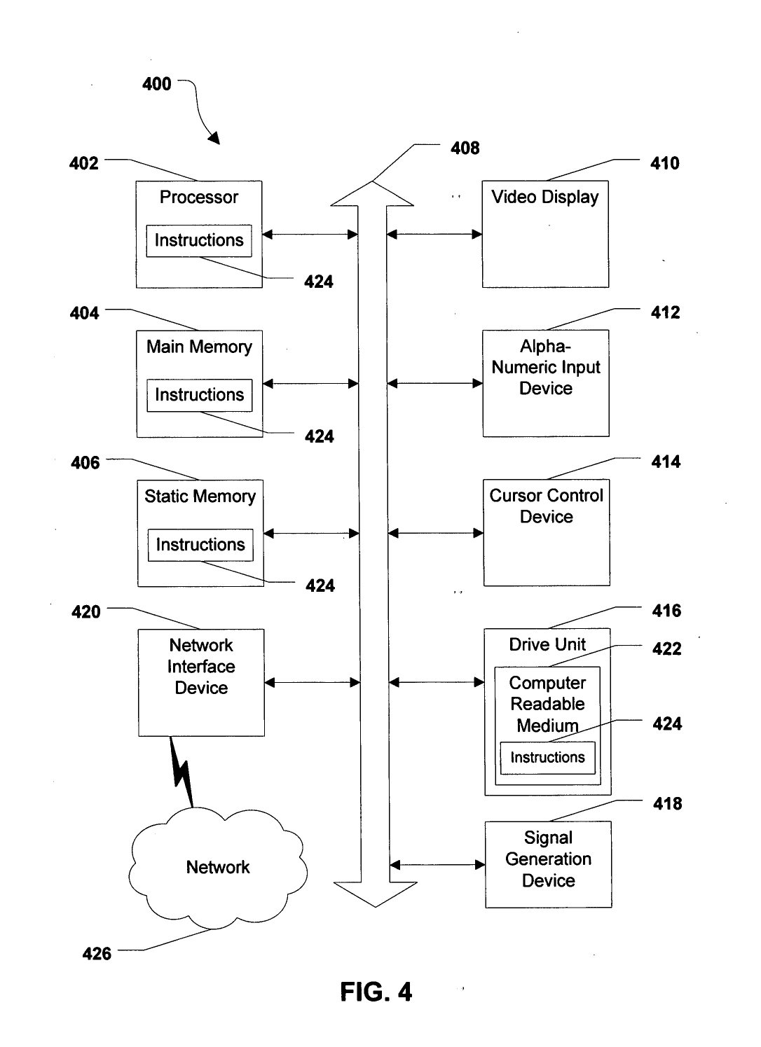

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various-embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
creating, by an artist during a Web teleconference session, a telephone directory advertisement for an advertiser based on an interaction via the Web teleconference session between the artist, the advertiser, and a sales representative.

2. The method of claim 1 further comprising:
communicating, from the artist to the sales representative via the Web teleconference session, at least one work-in-progress image of the telephone directory advertisement as the artist progresses in said creating the telephone directory advertisement.

3. The method of claim 1 further comprising:
communicating, from the artist to the advertiser via the Web teleconference session, at least one work-in-progress image of the telephone directory advertisement as the artist progresses in said creating the telephone directory advertisement.

4. The method of claim 1 further comprising:
receiving a telephone call from the sales representative;
providing a menu of a plurality of advertisement options in the telephone call;
receiving a selection of an advertisement option from the menu, the selection being made by the sales representative;
selecting the artist, from a plurality of artists, to create the telephone directory advertisement based on the advertisement option selected by the sales representative; and
routing the telephone call to the artist.

5. The method of claim 4 wherein the advertisement option comprises an option to create an in-column advertisement.

6. The method of claim 4 wherein the advertisement option comprises an option to create a display advertisement.

7. The method of claim 4 wherein said selecting the artist is based on a computer-readable profile of the artist stored in a computer-readable medium.

8. The method of claim 4 further comprising:
initiating, by the artist, the Web teleconference session.

9. The method of claim 8 further comprising:
inviting the sales representative and the advertiser to join the Web teleconference session.

10. The method of claim 1 further comprising:
receiving an approval of the telephone directory advertisement from the advertiser via the Web teleconference session.

11. The method of claim 1 further comprising:
publishing the telephone directory advertisement in a telephone directory.

12. A method comprising:
providing a Web teleconference session that is used by an artist to create a telephone directory advertisement for an advertiser based on interaction via the Web teleconference session between the artist, the advertiser, and a sales representative.

13. A system comprising:
a Web teleconference system to provide a Web teleconference session within which an artist creates a telephone directory advertisement for an advertiser based on interaction via the Web teleconference session between the artist, the advertiser, and a sales representative.

14. The system of claim 13 wherein the Web teleconference system is to communicate, from the artist to the sales representative via the Web teleconference session, at least one work-in-progress image of the telephone directory advertisement as the artist progresses in creating the telephone directory advertisement.

15. The system of claim 13 wherein the Web teleconference system is to communicate, from the artist to the advertiser via the Web teleconference session, at least one work-in-progress image of the telephone directory advertisement as the artist progresses in creating the telephone directory advertisement.

16. The system of claim 13 further comprising:
a processor to receive a telephone call from the sales representative, to provide a menu of a plurality of advertisement options in the telephone call, and to receive a selection of an advertisement option from the menu, the selection being made by the sales representative; and
an artist assigner to select the artist from a plurality of artists to create the telephone directory advertisement based on the advertisement option selected by the sales representative, the artist assigner to route the telephone call to the artist.

17. The system of claim 16 wherein the advertisement option comprises an option to create an in-column advertisement.

18. The system of claim 16 wherein the advertisement option comprises an option to create a display advertisement.

19. The system of claim 16 wherein the artist is selected based on a computer-readable profile of the artist stored in a computer-readable medium.

20. A computer-readable medium having computer-readable program code to cause a computer system to:
receive a telephone call;
provide, in the telephone call, a menu of a plurality of advertisement options, the plurality of advertisement options including a first option to create an in-column advertisement for a telephone directory and a second option to create a display advertisement for the telephone directory;
receive, in the telephone call, a selection of an advertisement option from the menu;
select an artist, from a plurality of artists, to create a telephone directory advertisement based on the selection of the advertisement option; and
route the telephone call to the artist.
